(19) United States
(12) Patent Application Publication
(10) Pub. No.: US 2004/0009339 A1
(43) Pub. Date: Jan. 15, 2004

(54) Material holder for use on steep pitched surfaces

(76) Inventor: Steven N. Case, West Valley, UT (US)

Correspondence Address: Brent T. Winder, Jones Waldo Holbrook & McDonough, Suite 1500, 170 South Main Street, Salt Lake City, UT, 84101, US

(21) Appl. No.: 10/611,018

(22) Filed: Jul. 1, 2003

Related U.S. Application Data
(60) Provisional application No. 60/393,326, filed on Jul. 1, 2002.

(51) Int. Cl. B32B 27/00

(52) U.S. Cl. 428/319.3; 428/304.4

(57) ABSTRACT

A material holder designed to aid a rooftop worker, such as a roofing installer, in more safely and effectively placing and storing materials, such as roofing materials, on a roof. A unitary cut or mold of sponge-like and firm material, such as composite or foam rubber, is designed to roughly mirror the angle of a roof's rise and run, or “pitch”. The unitary material is placed atop the roof surface, whereupon an amount of roofing material, such as a bundle of asphalt shingles, may be stacked. The unitary material need not be otherwise fastened to the roof surface because the exceptional quotient of friction achieved by contact of the unitary material with the roof under heavy loads is sufficient to prevent slippage.

### RELATED APPLICATIONS

This application claims priority from U.S. Provisional Patent Application No. 60/393,326, filed Jul. 1, 2002, and is hereby incorporated by reference for its supporting teachings.

### FIELD OF THE INVENTION

The present invention relates generally to material securing devices. Specifically, the present illustrated embodiments describe a type of material holder designed to aid a rooftop worker, such as a roofing installer, in more safely and effectively placing and storing materials, such as a bundle of asphalt shingles, on a roof.

### BACKGROUND OF THE ILLUSTRATED EMBODIMENT(S) AND PRIOR ART

Rooftop workers are subject to a myriad of risks while performing their labors. Among these risks are the ever present concerns of: slipping and falling off of a roof or similar structure due to unbalanced material loads; causing a load of material to slide off of a roof or similar structure; and damaging roofing materials by causing the same to slide off of a roof or similar structure. To mitigate these risks, there are several methods or tools utilized by rooftop workers to protect against slippage of materials. For example, rooftop workers often utilize plywood and/or dimensional jacks for supporting loads of roofing materials. Alternatively, many roofing contractors and materials suppliers instruct their laborers to stack the roof ridge with often extremely heavy material loads. It is well recognized that these typical and well-known methods have inherent problems.

Using jacks to support material loads on a roof requires considerable labor to install, damages the roof underlayment, and often creates a support that lacks sufficient surface friction to hold a heavy bundle of roofing materials. In addition, ridge loading may compromise a roof's structural integrity thereby posing a serious risk of injury or damage to the workers or structure. Furthermore, ridge loading also poses risks of slippage as the roofing underlayment, such as plywood or felt, often lacks sufficient surface friction to hold a heavy bundle, or stack of bundles, of roofing material.

Thus, it can be clearly recognized that there is a need for a device designed to provide workers with the appropriate angle of repose and traction required to prevent, or drastically reduce, the amount of material slippage resulting from material stacked on steep pitched surfaces. It is also clearly recognized that there is a need for a similar device that is designed to prevent excessive loading on particular portions of a roof or similar structure.

### SUMMARY OF THE ILLUSTRATED EMBODIMENT(S)

The present invention relates generally to material securing devices. Specifically, the present illustrated embodiments describe a type of material holder designed to aid a rooftop worker, such as a roofing material installer, in more safely and effectively placing roofing materials, such as a bundle of asphalt shingles, on a roof.

More particularly, a unitary cut or mold of sponge-like and firm material, such as composite or foam rubber, is designed to roughly mirror the angle of a roof's rise and run, or “pitch”. The unitary material is placed atop the roof surface, whereupon an amount of roofing material, such as a bundle of asphalt shingles, may be stacked. The unitary material need not be otherwise fastened to the roof surface because the exceptional quotient of friction achieved by contact of the unitary material with the roof under heavy loads is sufficient to prevent slippage.

Additional features and advantages of the invention will be set forth in the detailed description which follows, taken in conjunction with the accompanying drawings, which together illustrate by way of example, the features of the invention.

### BRIEF DESCRIPTION OF THE FIGURES

The prior features of the summary of the illustrated embodiment(s) will become more evident upon examination of the following detailed description in conjunction with the following figures, wherein like element numbers represent like elements throughout:

FIG. 1 represents a rear end view of an embodiment of the present invention;

FIG. 2 represents a side view of an embodiment of the present invention of FIG. 1;

FIG. 3 represents a front-end view of an embodiment of the present invention of FIG. 1;

FIG. 4 represents a perspective view of an embodiment of the present invention of FIG. 1;

FIG. 5 represents a rear end view of an embodiment of the present invention;

FIG. 6 represents a side view of an embodiment of the present invention of FIG. 5;

FIG. 7 represents a front end view of an embodiment of the present invention of FIG. 5; and

FIG. 8 represents a perspective view of an embodiment of the present invention of FIG. 5.

### DETAILED DESCRIPTION OF THE ILLUSTRATED EMBODIMENT(S)

For the purpose of promoting an understanding of some of the principles of the illustrated embodiment(s), reference will now be made to exemplary embodiment(s) that are illustrated in the figures, and specific language will be used to describe the same. It will nevertheless be understood that no limitation of the scope of the claims is thereby intended. Any alterations and further modifications of the inventive features illustrated herein, and any additional applications of these principles, which would occur to one skilled in the relevant art after having possession of this disclosure, are to be considered well within the scope of this invention. Reference will now be made to all of the FIGS., 1 through 8, of the present invention, wherein like element numbers represent like elements throughout.

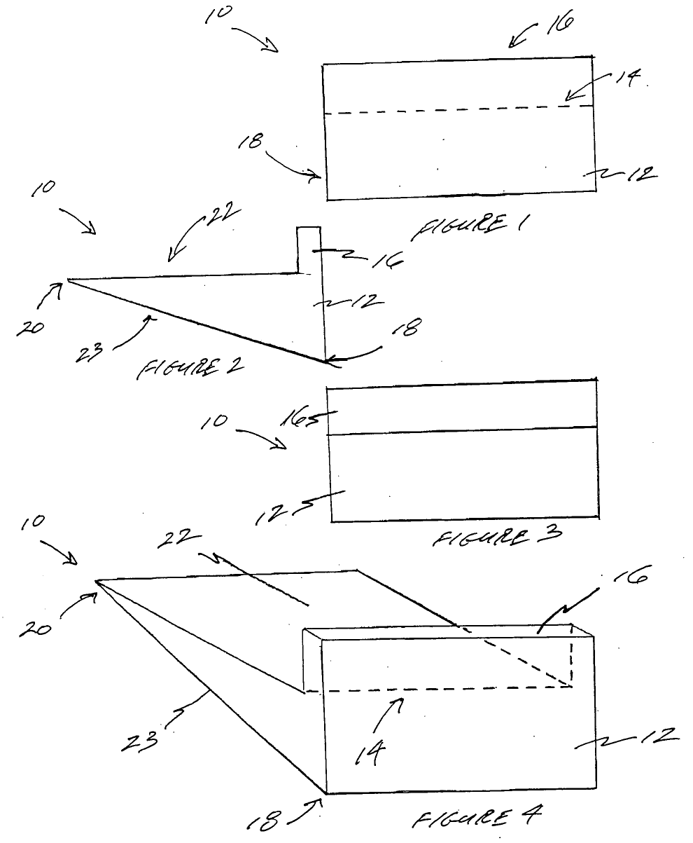

Referring to FIG. 1, an embodiment of the present invention 10 is shown and described in a rear end view. A unitary cut or mold of sponge like material, such as composite or foam rubber, forms a unitary base 12 of the present invention 10. The design of the unitary base 12 generally follows a triangular shape, which conforms to the general contour and shape of a roof's pitch while creating a relatively level surface upon which to place roofing materials. For the embodiment presently described, a material, or bundle, stop 16 is shown as a raised portion of the unitary base 12 on a deep end 18 of the unitary base 12. The material stop 16 is intended to retain a bundle or roll of roofing material and prevent the same from slipping off of a roof or similar structure. A material stop depth line 14 shows the distance from a top of the material stop 16 to a lower plane of the unitary base 12.

Referring now to FIG. 2, a side view of the embodiment of the present invention 10 as depicted in FIG. 1 is shown and described. For the embodiment presently described, a material platform 22, which is a relatively level surface of the unitary base 12, is shown and functions as the surface upon which to place or store roofing materials. Conversely, on an opposite side of the unitary base 12, a roof contact surface 23 is shown. The roof contact surface 23 is designed to lie flat against the roof or similar surface to maximize surface to surface friction coefficients. A shallow end 20 of the unitary base 12 is also shown. The shallow end 20 is designed to be placed on an upper side of a roof's pitch, i.e. pointing to its peak(s), and the deep end 18 of the unitary base 12 is designed to be placed on a lower side of the roof's pitch, i.e. pointing to its eave(s).

Referring now to FIG. 3, a front-end view of the embodiment of the present invention 10 as depicted in FIG. 1 is shown and described.

Referring now to FIG. 4, a perspective view of the embodiment of the present invention 10 as depicted in FIG. 1 is shown and described.

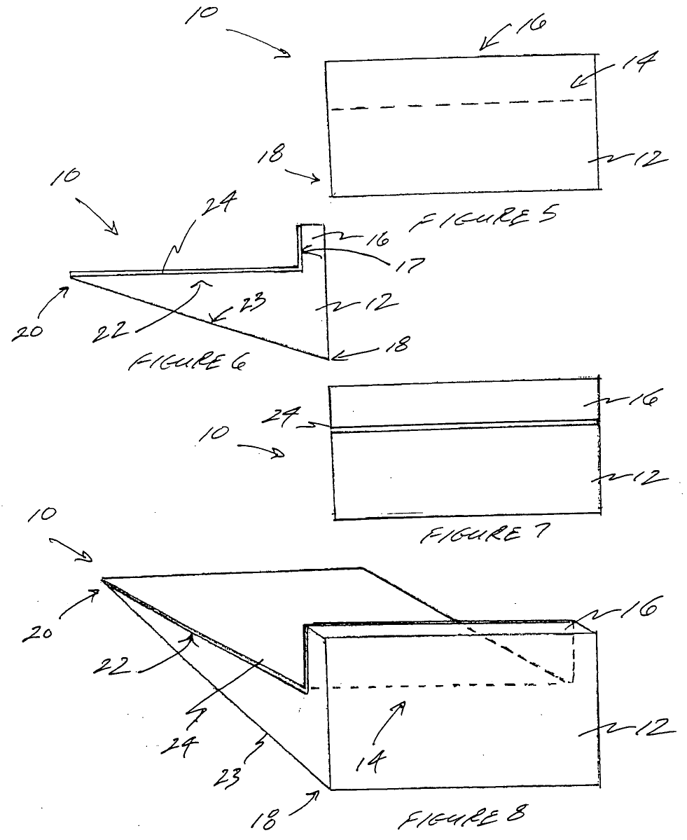

Referring now to FIG. 5, an embodiment of the present invention 10 is shown and described in a rear end view.

Referring now to FIG. 6, a side view of the embodiment of the present invention 10 as depicted in FIG. 5 is shown and described. For the embodiment presently described, a material platform liner 24 is shown as integrally attached to the surface of the material platform 22. The material platform liner 24 may be made of metal, laminate, plastic, high-density rubber, wood, or synthetic material. The material platform liner 24 may serve to protect the unitary base from ripping, tearing, or other damage. The material platform liner 24 may also strengthen the unitary base and allow the same to hold heavier loads. The material platform liner 24 may also prevent saturation of the unitary base 12 in the event of rain, or other moisture accumulation on or about a roof surface. The material platform liner 24 is designed to entirely cover a vertical face 17 of the material stop 16, which vertical face 17 faces the material platform 22.

Referring now to FIG. 7, a front view of the embodiment of the present invention 10 as depicted in FIG. 5 is shown and described.

Referring now to FIG. 8, a perspective view of the embodiment of the present invention 10 as depicted in FIG. 5 is shown and described.

Remarks about the Illustrated Embodiment(s)

The illustrated embodiments have taught several improvements over previously known methods of securing materials atop steep pitched surfaces that will be readily understood by a skilled artisan after review of the present disclosure. For example, it has been discussed that the unique combination of the shape and material of the present invention, made from composite or foam rubber, will allow rooftop workers to more safely set and temporarily store materials, such as bundles of roof shingles, will reduce the risk of material damage due to slippage, and will reduce the risk of structural damage to a roof or similar structure due to over-loading.

It is pointed out, if it has not already been made clear, that the backbone of the illustrated embodiments to achieve the aforementioned tasks is the ability of the present invention to maximize roof surface to material holder surface friction values. This is accomplished through the unique design of the unitary base 12, which closely mirrors the pitch of a roof. The severity of the angle required depends upon the pitch of the subject roof. Further, the addition of the material stop 16 prevents small tools or round bundles of material from rolling and potentially falling from a roof or similar surface.

Based on the reasons outline above, the present invention may ultimately serve to reduce costs to roofing contractors by reducing the amount of replacement material(s) needed to compensate for lost or damaged roofing materials. In addition, the present invention may drastically reduce the incidence of material slip related injuries for roof-top workers or other ground workers, and may reduce the incidence of structural damage to a roof or similar structure through over the over-loading of ridges.

Variations of the Illustrated Embodiment(s)

It is understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements.

For example, although the illustrative embodiments have described the use of composite and/or foam rubber base materials, a water-resistant material may also be utilized within the scope of the present invention. For example, a tar-coated embodiment may be utilized within the scope of the present invention. Any material of similar density and performance as composite or foam rubbers may be implemented as the base material for the present invention. Also, any number of methods for securing the material platform liner 24 to the unitary base 12, including but not limited to adhesive, injection molding, rivets, pegs, and heat seal, are envisioned within the scope of the present invention.

The present invention also contemplates variations in the relative angles depicted. For example, the difference in height between the shallow end 20 of the unitary base 12 and the deep end 18 may be drastically altered to accommodate the pitch of any roof. The present invention 10 may be designed to accommodate any pitch by increasing or decreasing the depth of the unitary base 12 on the deep end 18 to match the specific rise of the roof. Similarly, the height of the material stop 16 may be altered to accommodate more or less material, depending on the requirements of a specific application.

Thus, while the present invention has been shown in the drawings and fully described above with particularity and detail in connection with what is presently deemed to be the most practical and preferred embodiments of the invention, it will be apparent to those of ordinary skill in the art that numerous modifications, including, but not limited to, variations in size, materials, shape, form, function, and manner of operation, assembly, and use may be made, without departing from the principles and concepts of the invention as set forth in the claims.

What is claimed is:

1. A roofing bundle holder, comprising:
a) a unitary base, having a general triangular shape, designed for placement atop a roof surface, wherein the unitary base comprises:
i) a shallow end, designed for directional placement on a ridge side of a slope of the roof surface,
ii) a deep end, designed for directional placement on an eave side of a slope of the roof surface,
iii) a bundle platform, formed on a first side of the unitary base, designed to receive roofing bundles, and
iv) a roof contact surface, formed on a second side of the unitary base, designed to rest on the roof surface; and
b) a bundle stop, integrally attached to the unitary base adjacent the material placement platform as a raised portion of the deep end of the unitary base, designed to retain roofing bundles atop the bundle platform.

2. The roofing bundle holder of claim 1, wherein the unitary base and bundle stop are made of foam rubber.

3. The roofing bundle holder of claim 1, wherein the unitary base and bundle stop are made of composite rubber.

4. The roofing bundle holder of claim 1, wherein the unitary base and bundle stop are made of sponge rubber.

5. A roofing bundle holder, comprising:
a) a unitary base, having a general triangular shape, designed for placement atop a roof surface, wherein the unitary base comprises:
v) a shallow end, designed for directional placement on a ridge side of a slope of the roof surface,
vi) a deep end, designed for directional placement on an eave side of a slope of the roof surface,
vii) a bundle platform, formed on a first side of the unitary base, designed to receive roofing bundles, and
viii) a roof contact surface, formed on a second side of the unitary base, designed to rest on the roof surface;
c) a bundle stop, integrally attached to the unitary base adjacent the material placement platform as a raised portion of the deep end of the unitary base, designed to retain roofing bundles atop the unitary base; and
d) a bundle platform liner, integrally attached to the bundle platform and bundle stop as a thin veneer, designed to strengthen and protect the unitary base and bundle stop.

6. The roofing bundle holder of claim 5, wherein the unitary base and bundle stop are made of foam rubber.

7. The roofing bundle holder of claim 5, wherein the unitary base and bundle stop are made of composite rubber.

8. The roofing bundle holder of claim 5, wherein the unitary base and bundle stop are made of sponge rubber.

9. A material holder for use on steep pitched surfaces, comprising:
a) a unitary base, having a general triangular shape, designed for placement atop a steep pitched surface, wherein the unitary base comprises:
i) a shallow end, designed for directional placement on an higher side of a slope of the steep pitched surface,
ii) a deep end, designed for directional placement on a lower side of a slope of the steep pitched surface,
iii) a material platform, formed on a first side of the unitary base, designed to retain material placed upon the unitary base, and
iv) a contact surface, formed on a second side of the unitary base, designed to rest on the steep pitched surface; and
i) a bundle stop, integrally attached to the unitary base adjacent the material placement platform as a raised portion of the deep end of the unitary base, designed to hold material atop the material platform.

10. The roofing bundle holder of claim 9, wherein the unitary base and bundle stop are made of foam rubber.

11. The roofing bundle holder of claim 9, wherein the unitary base and bundle stop are made of composite rubber.

12. The roofing bundle holder of claim 9, wherein the unitary base and bundle stop are made of sponge rubber.
